(19) United States
(12) Patent Application Publication
(10) Pub. No.: US 2014/0379631 A1
(43) Pub. Date: Dec. 25, 2014

(54) TRANSACTIONAL KEY-VALUE DATABASE WITH SEARCHABLE INDEXES

(71) Applicant: Linkedln Corporation, Mountain View, CA (US)

(72) Inventors: Abraham Sebastian, Santa Clara, CA (US); Swaroop Jagadish, Mountain View, CA (US); Yun Sun, Sunnyvale, CA (US); Robert M. Schulman, Menlo Park, CA (US); Shirshanka Das, Mountain View, CA (US)

(21) Appl. No.: 13/935,130

(22) Filed: Jul. 3, 2013

Related U.S. Application Data
(60) Provisional application No. 61/839,251, filed on Jun. 25, 2013.

(51) Int. Cl. G06F 17/30

(52) U.S. Cl. CPC G06F 17/30424
USPC 707/607

(57) ABSTRACT

During a search technique, indexes associated with user accounts of users that are using the communication application are opened in memory from a transactional key-value database. These indexes encompass messages (such as emails) communicated using the communication application, and each of the users has at least one separate, associated index. When a search query associated with a target user account is received from the communication application, a search based on the search query is performed by reading the associated index in the memory from the transactional key-value database without managing the index using a file system. Then, a result for the search query is returned.

### CROSS REFERENCE TO RELATED APPLICATION

This application claims priority under 35 U.S.C. §119(e) to U.S. Provisional Application Ser. No. 61/839,251, entitled “Transactional Key-Value Database with Searchable Indexes,” by Abraham Sebastian, Swaroop Jagadish, Yun Sun, Robert M. Schulan and Shirshanka Das, Attorney Docket No. LI-P0216.LNK.PROV, filed on Jun. 25, 2013, the contents of which are herein incorporated by reference.

This application is related to U.S. Non-Provisional application Ser. No. TBA, entitled “Message Index Subdivided Based on Time Intervals,” by Swaroop Jagadish, Abraham Sebastian, Yun Sun and Shirshanka Das, attorney docket number LI-P0212.LNK.US, filed on Jul. 3, 2013, the contents of which are herein incorporated by reference.

### BACKGROUND

1. Field

The described embodiments relate to techniques for performing searches associated with a communication application. More specifically, the described embodiments relate to techniques for opening indexes of messages associated with active user accounts for the communication application in memory to facilitate performing searches based on search queries.

2. Related Art

Incoming and outgoing messages associated with a communication application (such as emails associated with an email application) are often stored in data structures for subsequent use. For example, the messages may be stored in a message table and, to facilitate fast access to particular types of messages (such as unread or read messages), the messages are often indexed.

However, there may be a large number of users of a communication application, such as one million users or more. When there are this many users, it can be time-consuming and difficult to open the index. It can also be difficult to perform subsequent operations on the index, such as searches for particular types of messages or for content (e.g., keywords) in the messages. These delays are frustrating to users and can degrade the user experience when using the communication application.

### BRIEF DESCRIPTION OF THE FIGURES

FIG. 1 is a flow chart illustrating a method for performing a search associated with a communication application in accordance with an embodiment of the present disclosure.

FIG. 2 is a flow chart further illustrating the method of FIG. 1 in accordance with an embodiment of the present disclosure.

FIG. 3 is a block diagram illustrating a system that performs the method of FIGS. 1 and 2 in accordance with an embodiment of the present disclosure.

FIG. 4 is a drawing illustrating a social graph in accordance with an embodiment of the present disclosure.

FIG. 5 is a block diagram illustrating a computer system that performs the method of FIGS. 1 and 2 in accordance with an embodiment of the present disclosure.

FIG. 6 is a block diagram illustrating a data structure for use in the computer system of FIG. 5 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a technique for performing a search query associated with a communication application, and a computer-program product (e.g., software) for use with the computer system are described. During this search technique, indexes associated with user accounts of users that are using the communication application are opened in memory from a transactional key-value database. These indexes encompass (i.e., index or summarize) messages (such as emails) communicated using the communication application, and each of the users has at least one separate, associated index. When the search query associated with a target user account is received from the communication application, a search based on the search query is performed by reading the associated index in the memory from the transactional key-value database without managing the index using a file system. Then, a result for the search query is returned.

In this way, the search technique may ensure that the indexes of active users can be opened and that subsequent operations (such as searches) can be performed on the indexes quickly. Furthermore, message tables with the messages, which correspond to the indexes, may be included in the transactional key-value database. The use of a transactional key-value database may ensure: read-write consistency between the messages and the indexes; the ability to back up the messages and the indexes (which may facilitate fast restores); and the ability to replicate the messages and the indexes. Thus, the search technique may improve the performance and the reliability of the communication application, thereby improving the user experience when using the communication application. This may increase customer loyalty, as well as revenue, of the communication application.

In the discussion that follows, an individual, a user or a recipient of the content may include a person (for example, an existing customer, a new customer, a student, an employer, a supplier, a service provider, a vendor, a contractor, etc.). More generally, the search technique may be used by an organization, a business and/or a government agency. Furthermore, a ‘business’ should be understood to include: for-profit corporations, non-profit corporations, groups (or cohorts) of individuals, sole proprietorships, government agencies, partnerships, etc.

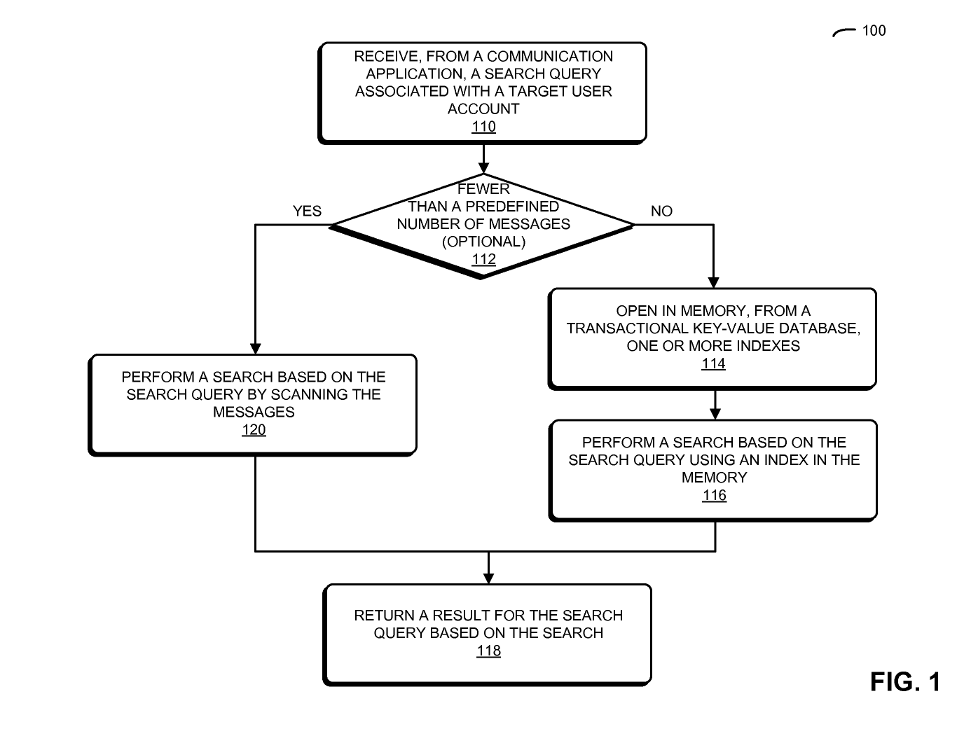

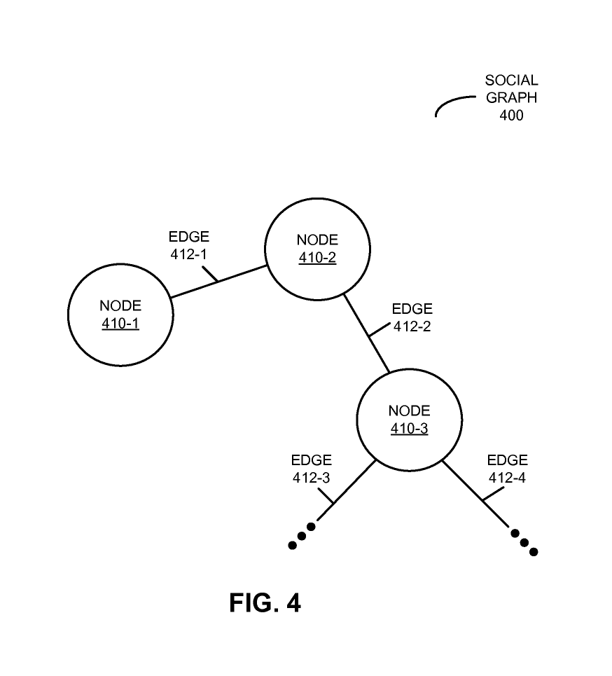

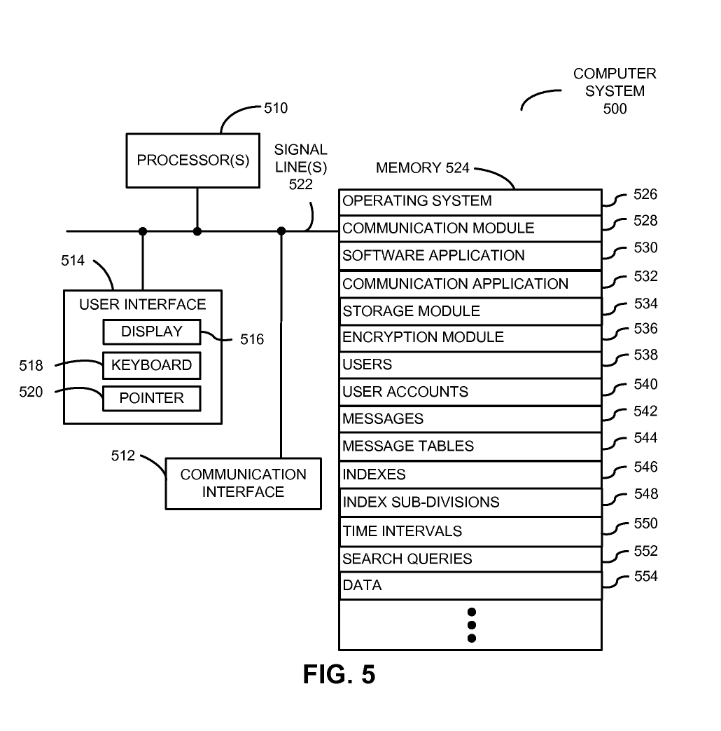

We now describe embodiments of the method. FIG. 1 presents a flow chart illustrating a method 100 for performing a search associated with a communication application, which may be performed by a computer system (such as computer system 500 in FIG. 5). During operation, the computer system receives, from the communication application, a search query associated with a target user account (operation 110). The search query may be related to one or more messages associated with the user associated with the target user account, which were communicated using the communication application. For example, the one or more messages may be emails, and the communication application may be an email application. As another example, the one or more messages may be instant messages and the communication application may be an instant-messaging application. Moreover, as described further below with reference to FIG. 4, this user may have professional interconnections with other users of the communication application as specified by a social graph.

Note that the computer system may store the one or more messages in a message table associated with the user. Furthermore, the computer system may index the one or more messages in an index uniquely associated with the user. This index is also uniquely associated with the corresponding message table.

The index may be used to improve the performance of the computer system when performing a search based on the received search query. This may entail opening the index. In practice, the communication application may be used by a large number of users (e.g., there may be millions of users), each of which may have at least one uniquely associated message table and index. However, it may be difficult and time consuming to concurrently open such a large number of indexes. Indeed, it may be difficult to open such a large number of indexes in memory (such as volatile memory, e.g., DRAM) in the computer system.

Typically, a small percentage of the users may be active at a given time (e.g., 1-2%), so the indexes for the entire dataset do not need to be opened concurrently. Consequently, the computer system may only open in memory those indexes that are associated with ‘active’ accounts of users of the communication application (i.e., accounts for users that are currently using or are likely to use the communication application within a relatively short time interval). For example, active user accounts may include accounts of users who are logged in; and/or are accessing their accounts via a network, such as the Internet. In some embodiments, receiving the search query may indicate that the target user account is active.

Therefore, the computer system opens in memory from a transactional key-value database (e.g., on a hard-disk drive), one or more indexes (operation 114) that are associated with user accounts of users of the communication application (possibly including an index for the target user account). Note that the indexes may be stored in a single (i.e., only one) transactional key-value database. In addition, the uniquely associated message tables may be included along with the indexes in the transactional key-value database.

The use of the transactional key-value database may facilitate: read-write consistency between the messages (or the message tables) and the indexes (e.g., the message tables and the associated indexes may be consistent even as changes are made); the ability to back up the messages and the indexes (which may facilitate fast restores); and the ability to replicate the messages and the indexes. In an exemplary embodiment, the transactional key-value database includes Berkeley DB (from Oracle Corporation of Redwood Shores, Calif.) or MySQL (from Oracle Corporation of Redwood Shores, Calif.). Note that a transactional database may include an operational database of customer transactions and/or a database that tracks units of work (which is atomic, consistent, isolated and durable) performed by a database management system on a database. Similarly, a key-value database allows data (such as a key and an associated payload) to be stored without using a schema and may be item-oriented, in the sense that relevant data associated with an item are stored with it in the database.

Then, the computer system performs a search based on the search query using an index in memory (operation 116) associated with the target user account without managing the index using a file system. (If a file system is used, the amount of memory needed to open the indexes may be significantly increased.) For example, the computer system may use the index to determine the one or more messages that include data associated with the search query, and these one or more messages may be returned as a result for the search query. In an exemplary embodiment, the search query may request the most-recent messages (e.g., in the last week) and/or un-opened messages. Note that the result may be subject to a number-of-messages limit specified by the communication application. For example, the number-of-messages limit may specify a number of search-query results presented in a document by the communication application, such as a pagination limit of 15 messages per page.

Next, the computer system returns the result for the search query based on the search (operation 118).

However, in some embodiments only indexes associated with user accounts having more than a predefined number of messages (such as 100 messages) are opened in memory in operation 114. In these embodiments, before opening in memory an index associated with the target user account, the computer system may optionally determine if the target user account has fewer than the predefined number of messages (operation 112). If not, the index associated with the target user account is opened or read into memory (operation 114) from the transactional key-value database, and the search is performed based on the search query using the index in memory (operation 116). Alternatively, if the target account includes at least the predefined number of messages, the computer system may perform a search based on the search query by scanning the messages (operation 120) for the target user account without accessing the index.

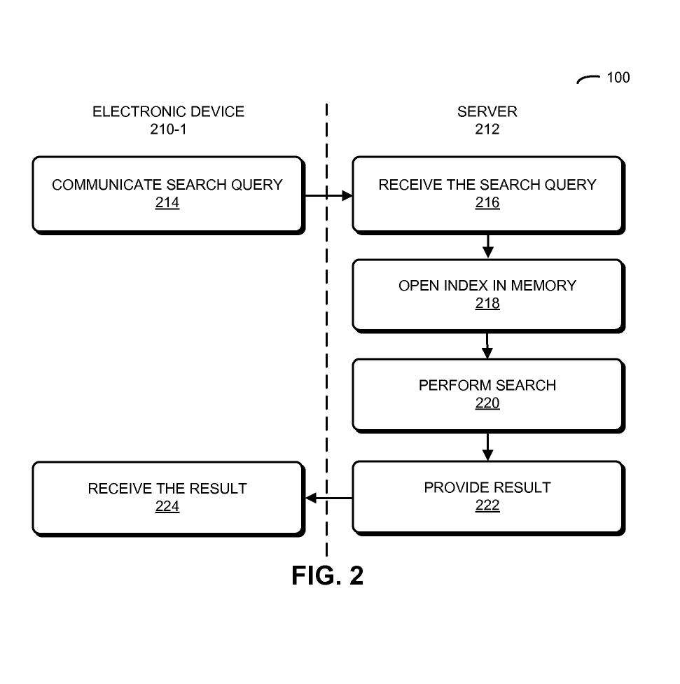

In an exemplary embodiment, the search technique is implemented using an electronic device (such as a computer, a cellular telephone and/or a portable electronic device) and at least one server, which communicate through a network, such as a cellular-telephone network and/or the Internet (e.g., using a client-server architecture). This is illustrated in FIG. 2, which presents a flow chart illustrating method 100 (FIG. 1). During this method, the user of electronic device 210-1 may communicate the search query (operation 214) using the communication application. When the search query is received (operation 216) by server 212, server 212 may open or read the index, which is associated with the target user account, in memory (operation 218) from the transactional key-value database.

Then, server 212 may perform the search (operation 220) based on the search query using the index. For example, the communication application may request the 15 most-recent unread emails, and server 212 may access the index to obtain data in response to this search query.

Next, server 212 may provide (operation 222) and electronic device 210-1 may receive (operation 224) the result.

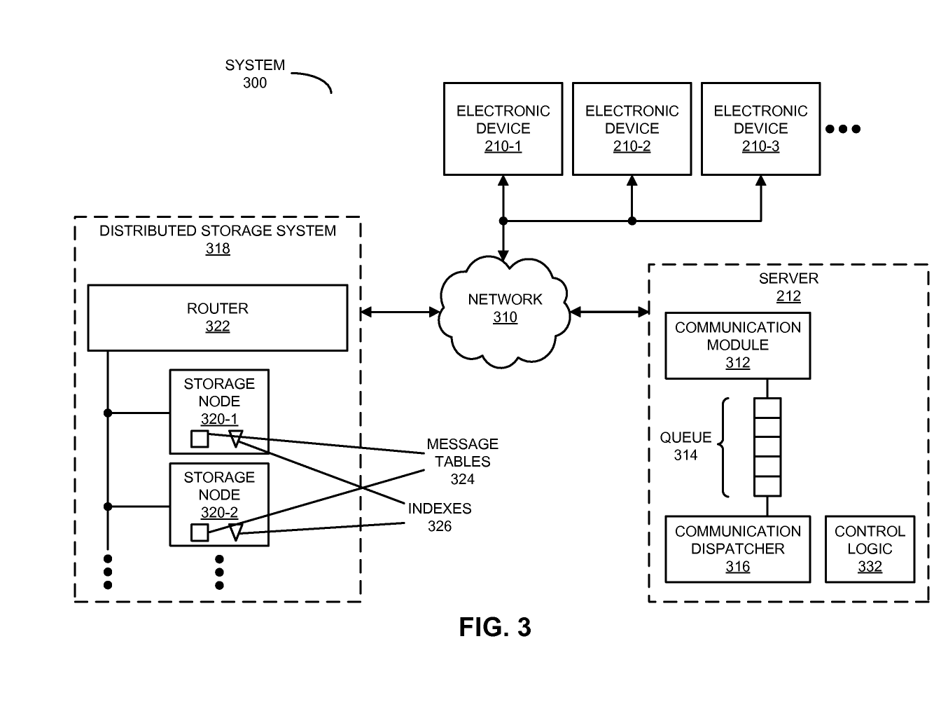

In some embodiments of method 100 (FIGS. 1 and 2), there may be additional or fewer operations. In particular, if the message table includes a large number of messages (such as 10,000 messages), the index uniquely associated with the message table may be time-partitioned or subdivided into buckets. For example, there may a bucket for messages having a timestamp between today and five days ago. This may facilitate the pagination supported by the communication application or, as described further below with reference to FIG. 3, a software application. When performing the search based on the search query, the computer system may sequentially access the buckets associated with the index. Moreover, the order of the operations may be changed, and/or two or more operations may be combined into a single operation.

In an exemplary embodiment, the search technique allows a 500 GB index to be stored on a computer system to only use 5-10 GB of memory to process search queries from active users. This may significantly reduce the hardware requirements and, thus, the expense associated with processing search queries.

We now describe embodiments of the system and the computer system, and their use. FIG. 3 presents a block diagram illustrating a system 300 that performs method 100 (FIGS. 1 and 2). In this system, a user of electronic device 210-1 may use a software product, such as a software application that is resident on and that executes on electronic device 210-1.

Alternatively, the user may interact with a web page that is provided by server 212 via network 310, and which is rendered by a web browser on electronic device 210-1. For example, at least a portion of the software application may be an application tool that is embedded in the web page, and which executes in a virtual environment of the web browser. Thus, the application tool may be provided to the user via a client-server architecture.

The software application operated by the user may be a standalone application or a portion of another application that is resident on and which executes on electronic device 210-1 (such as a software application that is provided by server 212 or that is installed and which executes on electronic device 210-1).

The user may use the software application (which may include the communication application) to communicate messages with other users of the software application on other electronic devices 210. For example, the user and the other users may be members of a social network (which, as described below with reference to FIG. 4, can be represented by a social graph), and the software application may allow the users to interact with each other within the social network. Furthermore, the user and the other users may each have mailboxes that include their messages (such as member-to-member messages within the social network, invitations for users to connect in the social graph, etc.), as well as the types of messages or the states of the messages (such as read, unread, etc.). Note that the communication application may support pagination. For example, the communication application may display a subset of the messages (such as 15/500 messages) per page.

When the user communicates the messages, the messages may be sent from electronic device 210-1 to server 212 via network 310. A communication module 312 (associated with the communication application) in a front-end of server 212 may output the messages to a queue 314 that feeds a communication dispatcher 316. Then, the messages may be communicated, via network 310, to the users of the other electronic devices 210.

Server 212 may also store the messages (and related attributes) in a distributed storage system 318. This distributed storage system may be a partitioned data storage system with multiple storage nodes 320 that each includes one or more databases associated with the communication application (such as a transactional key-value database, although other types of databases may be used). For example, mailboxes of the user and the other users may be partitioned across storage nodes 320. Thus, subsets of the mailboxes may be stored on particular storage nodes 320. This configuration may facilitate scaling of distributed storage system 318.

When storing the messages, a router 322 may convey the messages to the appropriate storage nodes 320 based on the users associated with the messages. Moreover, a given storage node (such as storage node 320-1) may store the messages in message tables 324 associated with the users (including the user and the other users), and may index information about these messages in corresponding indexes 326 associated with the users. For example, the messages for user B may be stored in user B′s message table, and information about these messages may be indexed in the corresponding index. Note that the messages and the information may include attributes of the messages (such as read, unread, keywords). This may allow the messages to be retrieved in response to a search query received from the instance of the software application on electronic device 210-1 based on the attributes (such as true/false searches or full-text searches).

For a small number of messages, all the user's messages can be indexed in a given partition or storage node in distributed storage system 318. Instead of indexing all of the messages in all the mailboxes in a storage node in one index, separate indexes may be created for each mailbox. This allows the indexes to be opened selectively, such as only opening indexes associated with active users.

However, some users may have very large mailboxes with 10,000 messages or more. A single index for such a user may be difficult to open in a timely manner in a relational database at the start of a user session. In addition, such large indexes can slow down other operations performed using the indexes. Therefore, indexes for users with large mailboxes (such as those with more than 10,000 messages) may be time-partitioned or sub-divided into buckets. For example, there may a bucket for messages having a timestamp between today and five days ago. This may facilitate the pagination supported by the software application. In particular, electronic device 210-1 may provide a request for the 15 most-recent messages for the user via network 310 (e.g., ?query: inBox=true AND count=15). In response, server 212 may access the index for the user in distributed storage system 318 starting with the bucket for messages having timestamps between today to five days ago (the current bucket), then the previous bucket (for messages having timestamps between five days ago and ten days ago), etc., until the 15 most-recent messages are found. Then, server 212 may provide the 15 messages to electronic device 210-1 via network 310.

If a total hit count for a search query is needed for a user account having a partitioned or subdivided index, all index buckets are opened and the search query may be executed on each of the buckets, and the resulting counts may be combined to get the total hit count. The counts for older buckets may be cached so that not all index buckets need to be opened the next time a count is required for the same search query. Moreover, the counts may be cached only for the most frequent search queries. Typically, the cached counts for older buckets are rarely invalidated as users rarely update older messages. In this way, total hit counts for search queries on a partitioned index may be efficiently computed without repeatedly opening all the index buckets. Caching counts in this way has very little overhead relative to the total amount of data in the message table or the index. This cache of counts may be maintained in volatile memory (such as DRAM), in which case the cache will be lost on process restarts. The cache can also be maintained in persistent storage, similar to the message table, in which case it is replicated and therefore highly available just like the message table. This approach may ensure that the cache survives process and machine restarts, and that a fully populated cache of counts is available in the event that a primary storage node fails and a standby storage node needs to take over.

In some embodiments, buckets or sub-divisions of a single index are organized based on the number of messages. For example, a message count or the total amount of data may be used as a basis for a new index partition. In particular, if the message-count limit is 5,000 messages per bucket, the buckets or sub-divisions may still be time-based. However, if the number of messages in a given bucket exceeds 5,000 messages, a new bucket may be created for additional messages (beyond 5,000) within the same time interval.

When a message is communicated for a user of the communication application (i.e., transmitted or received), server 212 may instruct distributed storage system 318 to update the message table and the associated index (and buckets) in one or more of storage nodes 320 in response to this transaction.

As discussed previously, when a search query associated with a particular or a target user account is received by server 212, one of indexes 326 in one of storage nodes 320 (such as storage node 320-1) may be opened or read in memory from the transactional key-value database. Then, server 212 may perform a search based on the search query using the index. For example, control logic in storage node 320-1 may use the index in memory to determine one or more messages in one of message tables 324 (which is uniquely associated with the index and the target user account). Information specifying the one or more messages may be returned by storage node 320-1 to server 212. Then, server 212 may provide the result (which includes the information) in response to the search query.

Note that distributed storage system 318 may allow backups of message tables 324 and indexes 326 (even for message tables and indexes that are currently being used). For example, control logic 332 may create backups of the data in one or more of storage nodes 320. In addition, distributed storage system 318 may be replicated. For example, changes may be written to message tables 324 and indexes 326 and then to replicas in real-time. The replicas may be stored on separate storage nodes 320. One of the replicas may be a ‘master’ and the others may be hot-standby ‘slaves,’ which control logic 332 can activate in the event of a failure in the master.

Information in system 300 may be stored at one or more locations in system 300 (i.e., locally and/or remotely relative to server 212). Moreover, because this data may be sensitive in nature, it may be encrypted. For example, stored data and/or data communicated via network 310 may be encrypted.

We now further describe the social graph. As noted previously, the users, their attributes, associated organizations (or entities) and/or their interrelationships (or connections) may specify a social graph. FIG. 4 is a drawing illustrating a social graph 400. This social graph may represent the connections or interrelationships among nodes 410 (corresponding to users, attributes of the users, entities, etc.) using edges 412. In the context of the search technique, social graph 400 may specify business information, and edges 412 may indicate interrelationships or connections between the users and organizations. However, in some embodiments, nodes 410 may be associated with attributes (such as skills) and business information (such as contact information) of the users and/or organizations.

In general, ‘entity’ should be understood to be a general term that encompasses: an individual, an attribute associated with one or more individuals (such as a type of skill), a company where the individual worked or an organization that includes (or included) the individual (e.g., a company, an educational institution, the government, the military), a school that the individual attended, a job title, etc. Collectively, the information in social graph 400 may specify profiles (such as business or personal profiles) of individuals.

FIG. 5 presents a block diagram illustrating a computer system 500 that performs method 100 (FIGS. 1 and 2). Computer system 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516 (such as a touchscreen), a keyboard 518, and/or a pointer 520, such as a mouse.

Memory 524 in computer system 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to computer system 500.

Memory 524 may also include multiple program modules (or sets of instructions), including: software application 530 (or a set of instructions), communication application 532 (or a set of instructions), storage module 534 (or a set of instructions), and/or encryption module 536 (or a set of instructions). Note that one or more of these program modules (or sets of instructions) may constitute a computer-program mechanism.

During operation of computer system 500, when using software application 530 (such as a software application that implements a social network), users 538 having user accounts 540 may communicate messages 542 associated with communication application 532 using communication module 528 and communication interface 512. Storage module 534 may store messages 542 in message tables 544 and may index information about messages 542 in indexes 546. Note that indexes 546 may be included in a transactional key-value database, and each of user accounts 540 may have at least one unique index in indexes 546.

If there are a large number of messages in a given message table, storage module 534 may sub-divide the associated index into index buckets or index sub-divisions 548 that correspond to messages received during different time intervals 550.

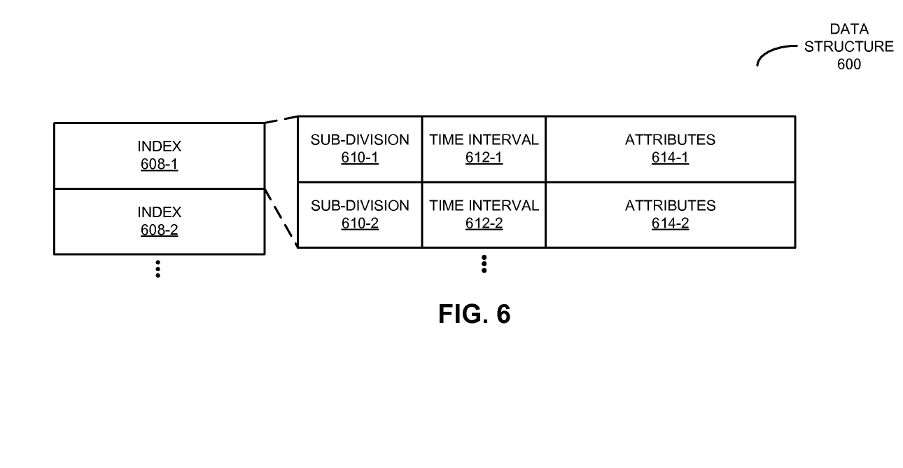

FIG. 6 presents a block diagram illustrating a data structure 600 with one or more indexes 608 for use in computer system 500 (FIG. 5). In particular, index 608-1 may include index sub-divisions 610 for time intervals 612, and an illustrative index may include: index sub-division 610-1, time interval 612-1 of these messages, and attributes 614-1 associated with the messages (such as keywords and types or states of the messages).

Referring back to FIG. 5, when search queries 552 associated with user accounts 540 for communication application 532 are received from users 538 via communication module 528 and communication interface 512, storage module 534 may open indexes 546 for these users in volatile memory. For a given search query, storage module 534 may perform a search based on the given search query using the associated index in volatile memory. This search may involve accessing one of message tables 544 uniquely associated with the index to obtain data 554 in response to the given search query.

Moreover, data 554 may be communicated to a given user as a result for the given search using communication module 528 and communication interface 512. In particular, storage module 534 may provide data 554 to an instance of software application 530 executing on an electronic device used by the given user via communication module 528 and communication interface 512.

Because information in computer system 500 may be sensitive in nature, in some embodiments at least some of the data stored in memory 524 and/or at least some of the data communicated using communication module 528 is encrypted using encryption module 536.

Instructions in the various modules in memory 524 may be implemented in: a high-level procedural language, an object-oriented programming language, and/or in an assembly or machine language. Note that the programming language may be compiled or interpreted, e.g., configurable or configured, to be executed by the one or more processors.

Although computer system 500 is illustrated as having a number of discrete items, FIG. 5 is intended to be a functional description of the various features that may be present in computer system 500 rather than a structural schematic of the embodiments described herein. In practice, and as recognized by those of ordinary skill in the art, the functions of computer system 500 may be distributed over multiple servers or computers, with various groups of the servers or computers performing particular subsets of the functions. In some embodiments, some or all of the functionality of computer system 500 is implemented in one or more application-specific integrated circuits (ASICs) and/or one or more digital signal processors (DSPs).

Computer systems (such as computer system 500), as well as electronic devices, computers and servers in system 300 (FIG. 3) may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 310 (FIG. 3) may include: the Internet, World Wide Web (WWW), an intranet, a cellular-telephone network, LAN, WAN, MAN, or a combination of networks, or other technology enabling communication between computing systems.

System 300 (FIG. 3), computer system 500 and/or data structure 600 (FIG. 6) may include fewer components or additional components. Moreover, two or more components may be combined into a single component, and/or a position of one or more components may be changed. In some embodiments, the functionality of system 300 (FIG. 3) and/or computer system 500 may be implemented more in hardware and less in software, or less in hardware and more in software, as is known in the art.

In the preceding discussion, separate indexes are maintained for each mailbox in the search technique. Each of these indexes may be partitioned independently of the other indexes, and metadata may be maintained for each individual index to indicate how it is partitioned. For example, an index for the mailbox of a given user may be partitioned if there is a lot of activity for this mailbox. In this way, only larger indexes (such as those associated with mailboxes having more than 5,000 messages) may be partitioned. This search technique is in contrast with the partitioning that is sometimes used in existing database management systems, in which indexes are sometimes time-partitioned based on fixed time intervals, so that there is an index partition for the last month, a different index partition for the six months prior to that, and another index partition for everything before that. The challenge with this existing approach is that there may be a lot of activity in a given month and the associated index partition could be unusually large, which may result in a performance penalty. By partitioning based on usage or the update rate to the index, the described search technique avoids this problem and is able to control performance (e.g., latency) more reliably.

While the preceding embodiments illustrated the search technique using a transactional key-value database, more generally the search technique may be used with an arbitrary key-value data structure and/or a wide variety of different types of relational databases.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-system-implemented method for performing a search associated with a communication application, the method comprising:
receiving from the communication application a search query associated with a first user account of a first user of the communication application; and
operating the computer system to:
open in memory, from a transactional key-value database, multiple indexes associated with user accounts of users of the communication application, including a first index associated with the first user account, wherein each index encompasses messages of the associated user account;
perform the search based on the search query using the first index, without managing the first index using a file system; and
return a result for the search query based on the search.

2. The method of claim 1, wherein only indexes of users logged into their user accounts are opened in the memory.

3. The method of claim 1, wherein only indexes of users currently accessing their user accounts via a network are opened in the memory.

4. The method of claim 1, wherein the transactional key-value database includes only one transactional key-value database.

5. The method of claim 1, wherein the indexes opened in the memory are associated with user accounts having more than a predefined number of messages.

6. The method of claim 5, wherein, if the first user account has fewer than the predefined number of messages, the search is performed by scanning the messages of the first user account without accessing the first index.

7. The method of claim 1, wherein the transactional key-value database facilitates read-write consistency between the multiple indexes and the messages of the associated user accounts.

8. A computer-program product for use in conjunction with a computer system, the computer-program product comprising a non-transitory computer-readable storage medium and a computer-program mechanism embedded therein, to perform a search associated with a communication application, the computer-program mechanism including:
instructions for receiving from the communication application a search query associated with a first user account of a first user of the communication application; and
instructions for operating the computer system to:
open in memory, from a transactional key-value database, multiple indexes associated with user accounts of users of the communication application, including a first index associated with the first user account, wherein each index encompasses messages of the associated user account;
perform the search based on the search query using the first index, without managing the first index using a file system; and
return a result for the search query based on the search.

9. The computer-program product of claim 8, wherein only indexes of users logged into their user accounts are opened in the memory.

10. The computer-program product of claim 8, wherein only indexes of users currently accessing their user accounts via a network are opened in the memory.

11. The computer-program product of claim 8, wherein the transactional key-value database includes only one transactional key-value database.

12. The computer-program product of claim 8, wherein the indexes opened in the memory are associated with user accounts having more than a predefined number of messages.

13. The computer-program product of claim 12, wherein, if the first user account has fewer than the predefined number of messages, the search is performed by scanning the messages of the first user account without accessing the first index.

14. The computer-program product of claim 8, wherein the transactional key-value database facilitates read-write consistency between the multiple indexes and the messages of the associated user accounts.

15. A computer system, comprising:
a processor;
memory; and
a program module, wherein the program module is stored in the memory and configurable to be executed by the processor to perform a search associated with a communication application, the program module including:
instructions for receiving from the communication application a search query associated with a first user account of a first user of the communication application; and
instructions for operating the computer system to:
open in the memory, from a transactional key-value database, multiple indexes associated with user accounts of users of the communication application, including a first index associated with the first user account, wherein each index encompasses messages of the associated user account;
perform the search based on the search query using the first index, without managing the first index using a file system; and
return a result for the search query based on the search.

16. The computer system of claim 15, wherein only indexes of users logged into their user accounts are opened in the memory.

17. The computer system of claim 15, wherein only indexes of users currently accessing their user accounts via a network are opened in the memory.

18. The computer system of claim 15, wherein the transactional key-value database includes only one transactional key-value database.

19. The computer system of claim 15, wherein the indexes opened in the memory are associated with user accounts having more than a predefined number of messages.

20. The computer system of claim 19, wherein, if the first user account has fewer than the predefined number of messages, the search is performed by scanning the messages of the first user account without accessing the first index.
